(19) United States
(12) Patent Application Publication
(10) Pub. No.: US 2011/0119970 A1
(43) Pub. Date: May 26, 2011

(54) WATER BALL ORNAMENT WITH BUBBLE CHAMBER

(76) Inventor: Jui-An TSAI, Tao Yuan Hsien (TW)

(21) Appl. No.: 12/624,977

(22) Filed: Nov. 24, 2009

(51) Int. Cl. G09F 19/00

(52) U.S. Cl. 40/406

(57) ABSTRACT

A water ball ornament with a bubble chamber is revealed. A closed container formed by a transparent container and a bottom cover that covers an opening edge of the transparent container is filled with a liquid. A bubble chamber is disposed projectingly under the bottom cover and having a through tube that connects with an inner space of the closed container so as to hide and receive bubbles generated in the closed container. When the closed container is rotated an angle to various positions, the liquid level in the bubble chamber is always over a lower end opening of the through tube so that the bubbles in the bubble chamber will not go back to the closed container.

### BACKGROUND OF THE INVENTION

The present invention relates to a water ball ornament with a bubble chamber, especially to a water ball ornament with a bubble chamber disposed projectingly under a bottom over of the water ball. A through hole that connects with a closed container of the water ball is disposed in the bubble chamber and a lower end opening of the through tube extends to a position near a center of to the bubble chamber so as to make the liquid level in the bubble chamber become above the lower end opening of the through tube when the water ball is rotated an angle to various positions. Thus bubbles hidden and received in the bubble chamber will not go back to the closed container.

The water ball ornament is a popular product including a transparent container such as a ball-shaped container, a bottom cover and a bottom base. The transparent container is made of glass by blow molding or made of plastic by blow molding or injection blow molding. That means a mold base is produced by an injection molding machine and then the flow molding process is performed. Then a bottom cover is covered on an opening on the bottom surface of the transparent container to form a closed container. A fixed ornament such as a figure, a plurality of white fragments (like snows), different colored lustrous foil fragments or various floaters are arranged in the closed container. Then a liquid is filled into the closed container through a filling hole preset on the bottom cover. When only one kind of liquid such as water is filled, the user can shake the water ball so as to make the foil fragments float freely. When double kinds of liquid such as transparent oil and water with blue dye are filled, the floaters move on an interface between two kinds of liquid. Later the closed transparent container is fixed above the bottom base. A plurality of components such as LED lighting devices or other transmission members can be mounted in the bottom base so as to increase interests and decoration effects of the water ball.

However, when there are certain changes in the temperature of surroundings, the closed container and the liquid filled therein may respectively have certain degrees of thermal expansion or contraction. For example, when the environmental temperature increases, the volume of the liquid filled also is increased to press the closed container and may even make the water ball crack when the pressure is over the load limit. While the temperature decreasing, the volume of the liquid filled is reduced so that bubbles are generated in the closed container and the bubbles further influence the appearance as well as the quality of the water ball. These are common shortcomings of water ball ornaments.

### SUMMARY OF THE INVENTION

Therefore it is a primary object of the present invention to provide a water ball ornament with a bubble chamber that includes a transparent container such as a ball-shaped container for display, a bottom cover for closing an opening on the bottom of the transparent container to form a closed container, and a bottom base for receiving the closed container. The water ball ornament features on that a bubble chamber is disposed pojectingly under the bottom cover. The bubble chamber and the closed container are separated by a partition plate while a through hole is arranged at the partition plate and a through tube extends downward from the through hole so as to make inner space of the closed container connect with the bubble chamber. Moreover, a lower end opening of the through tube is extending to a position near a center of the bubble chamber. Thus the bubble chamber has a sufficient space for hiding and receiving bubbles generated in the closed container. Therefore the influence of the bubbles on the appearance or the cracking of the water ball caused by the hydraulic pressure can be avoided. Furthermore, the liquid level in the bubble chamber is controlled to be over the lower end opening of the through tube so that the bubbles in the bubble chamber will not go back to the closed container through the through tube even the water wall is rotated a certain angle.

It is another object of the present invention to provide a water ball ornament with a bubble chamber in which the through hole is arranged close to one side of the partition plate and a curved through tube extends downward from the through hole while a lower end opening of the through tube extends to a position near a center of the bubble chamber.

It is a further object of the present invention to provide a water ball ornament with a bubble chamber in which a filling hole of the closed container is disposed on a bottom surface of the bubble chamber. The closed container is reversed to be filled with a liquid through the filling hole. When the closed container is full with liquid and the liquid flows into the bubble chamber, the amount of the liquid filled is controlled easily so as to make the liquid level become higher than the lower end opening of the through tube.

It is a further object of the present invention to provide a water ball ornament with a bubble chamber in which a mesh screen such as a metal mesh with small pores is fixed on the through hole of the partition plate to prevent foil fragments in the closed container entering through the through hole and clotting in the through tube, both of which have negative effects on the use of the bubble chamber.

It is a further object of the present invention to provide a water ball ornament with a bubble chamber in which the transparent container such as a ball-shaped container is made of transparent plastic such as PC (polycarbonate) or acrylic resin by blow molding or injection blow molding. A circular edge of the bottom cover is a step-like structure formed by an inner high step and an outer low step so as to make an opening edge of the transparent container is connected with the outer low step of the bottom cover by ultrasonic welding to form a closed container. Thereby the welding procedures of the transparent container with the bottom cover are simplified and the quality of the produced closed container is improved.

### BRIEF DESCRIPTION OF THE DRAWINGS

FIG. 1 is an explosive view of an embodiment according to the present invention;

FIG. 2 is a cross sectional view of a closed container of the embodiment in FIG. 1;

FIG. 3 to FIG. 6 are schematic drawings showing the closed container in FIG. 2 in a normal position, being rotated to a tilted position, a reverse position, and a reverse tilted position;

FIG. 7 is an explosive view of another embodiment according to the present invention;

FIG. 8 is a cross sectional view of a closed container of the embodiment in FIG. 7;

FIG. 9 to FIG. 12 are schematic drawings showing the closed container in FIG. 8 in a normal position, being rotated to a tilted position, a reverse position, and a reverse tilted position.

### DETAILED DESCRIPTION OF THE PREFERRED EMBODIMENT

### Embodiment 1

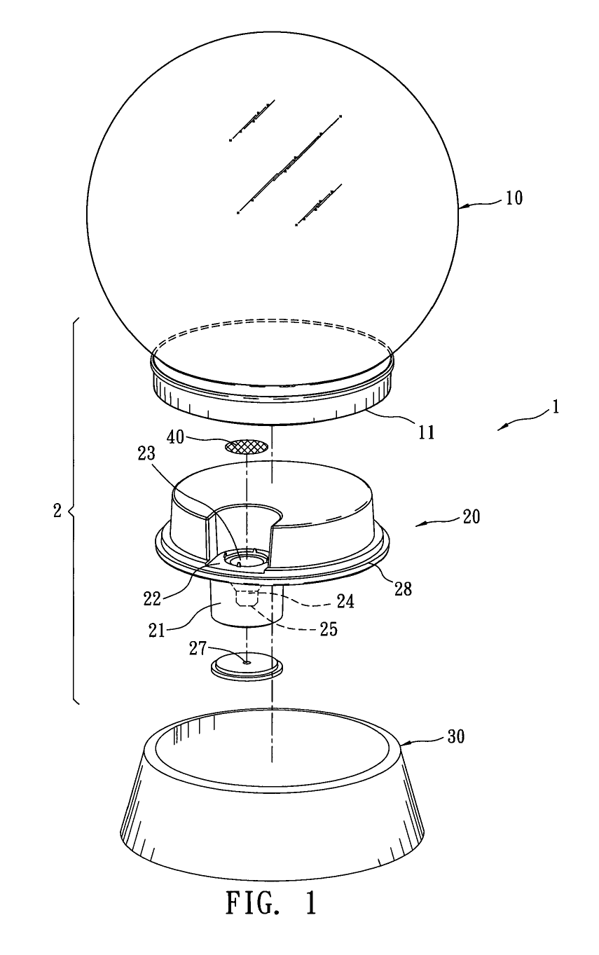

Refer from FIG. 1 to FIG. 6, a water ball ornament 1 with a bubble chamber in this embodiment includes a transparent container 10, a bottom cover 20 and a bottom base 30. The transparent container 10 can be a ball-shaped container made of glass by blow molding or made of plastic materials by blow molding or injection blow molding. An opening edge 11 is disposed on the bottom of the transparent container 10. The bottom cover 20 is adhered to the opening edge 11 on the bottom of the transparent container 10 to form a closed container 2 once the transparent container 10 is made of glass. The bottom cover 20 is ultrasonic welded to the opening edge 11 on the bottom of the transparent container 10 to form a closed container 2 once the transparent container 10 is made of plastic. The closed container 2 is fixed on the bottom base 30 to form a wall ball ornament 1.

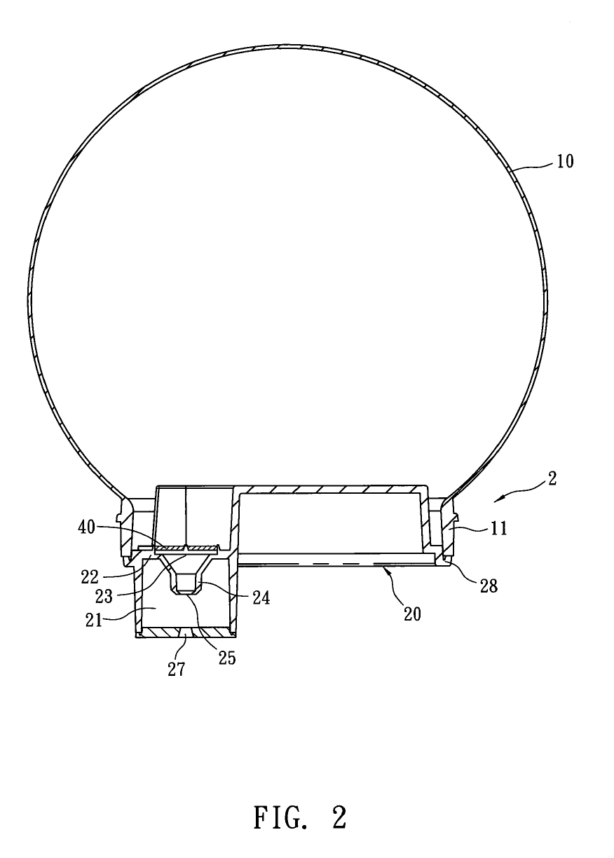

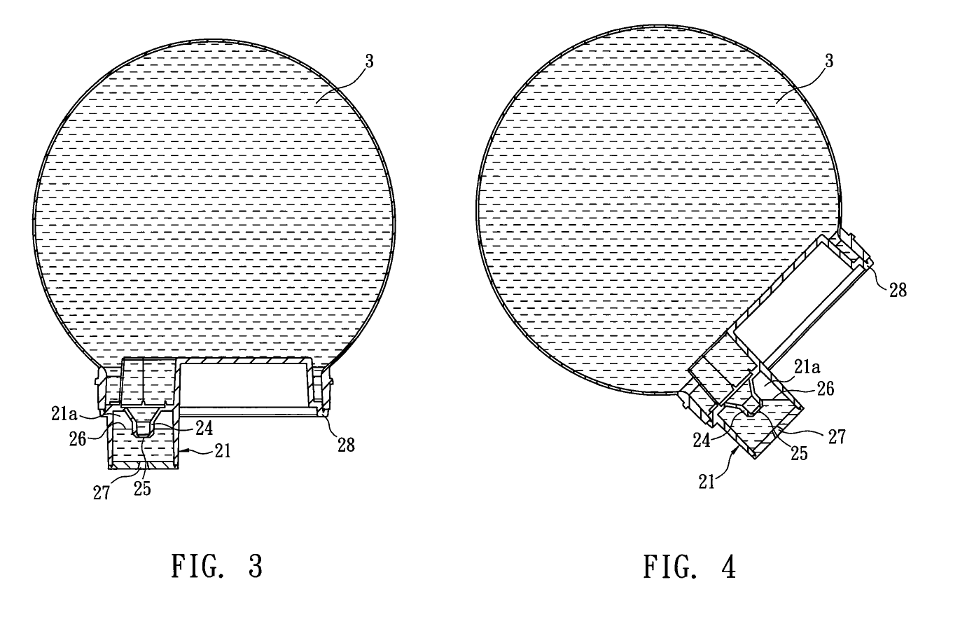

The water ball ornament 1 of the present invention features on that: a bubble chamber 21 is disposed projectingly downward on a bottom of a bottom cover 20 of the closed container 2. The bubble chamber 21 and the closed container 2 are divided by a partition plate 22. A through hole 23 is mounted on the partition plate 22 and a through tube 24 extends downward from the through hole 23 so as to make the closed container 2 connect with the bubble chamber 21. A lower end opening 25 of the through tube 24 is extending to a position near a center of a space of the bubble chamber 21, as shown in FIG. 1 & FIG. 2. Thus an upper space of the bubble chamber 21, above the lower end opening 25, is a sufficient space 21a shown in FIG. 3 for hiding and receiving bubbles generated in the closed container 2 so as to prevent the influence of the bubbles on the appearance. Moreover, the bubble chamber 21 is also used for providing hydraulic pressure regulation in the closed container 2 automatically so that the hydraulic pressure inside will not cause the water ball to crack.

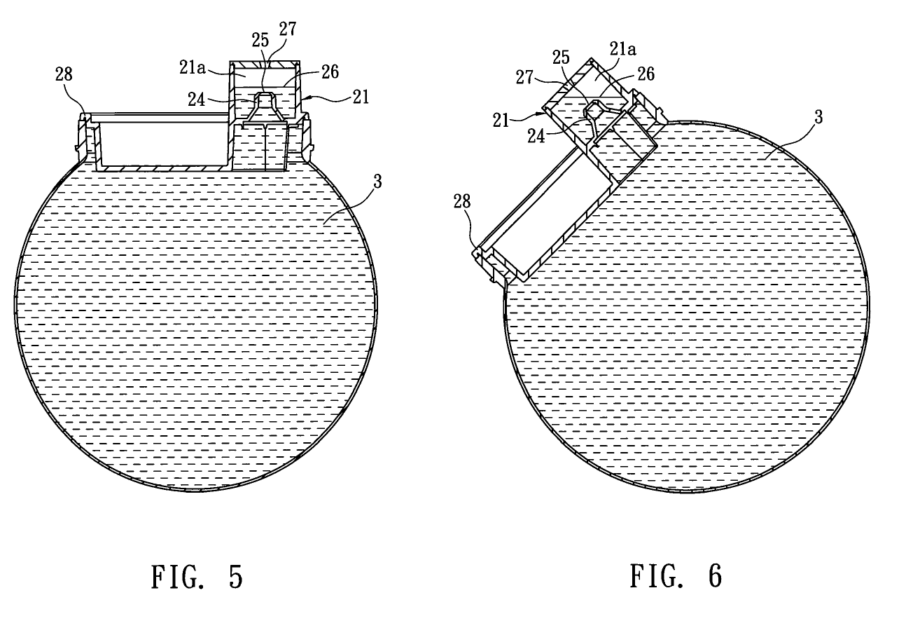

When bubbles are generated in the closed container 2 due to environmental temperature changes or other reasons, the bubbles can be collected and received in the bubble chamber 21. For example, the closed container 2 is moved to a reverse position and all the bubbles rise to the bubble chamber 21, as shown in FIG. 5. Then the closed container 2 is turned back to a normal position and the bubbles rise to form an air space 21a, as shown in FIG. 3. The volume of the bubble chamber 21 is designed according to the volume of the closed container 2 and a coefficient of thermal expansion/contraction. Moreover, the lower end opening 25 of the through tube 24 extends to a position near a center of the bubble chamber 21. Thus when a liquid 3 is filled into the closed container 2 is filled, the liquid level is controlled at least over the lower end opening 25 of the through tube 24, as shown in FIG. 3 and FIG. 5. Thus no matter the closed container 2 is rotated an angle to various positions such as a normal position, a titled position, a reverse position, and a reverse tilted position, the liquid level 26 of the liquid 3 in the bubble chamber 21 is always higher than the lower end opening 25 of the through tube 24. That means the lower end opening 25 is sunk into the liquid 3. Thus bubbles (air in the space 21a) will not enter the through tube 24 and turn back to the closed container 2 through the lower end opening 25.

As shown in FIG. 1 and FIG. 2, a filling hole 27 of the closed container 2 is disposed on a bottom surface of the bubble chamber 21 and is aligned with the lower end opening 25 of the through tube 24. While filling the liquid 3, the closed container 2 is reversed and is filled with the liquid 3 until the liquid 3 flows into the bubble chamber 21. Now by visual monitoring the amount of the liquid filled carefully, the liquid level 26 in the bubble chamber 21 is higher than the lower end opening 25 of the through tube 24. Thus the liquid filling process and the closing process are simplified.

Refer to FIG. 1 and FIG. 2, a mesh screen 40 such as a metal mesh with small pores is disposed above the through hole 23 on the partition plate 22, the opening of the through tube 24. Once the foil fragments enter and clot in the through tube 24, the bubble receiving and hydraulic pressure regulation functions of the bubble chamber 21 are affected. The mesh screen 40 can prevent the foil fragments (not shown in figure) in the closed container 2 entering through the through hole 23 and clotting in the through tube 24.

When the ball-shaped transparent container 10 is made of transparent plastic such as PC (polycarbonate) or acrylic resin by blow molding or injection blow molding, the transparent container 10 and the bottom cover 20 are integrated with each other by ultrasonic welding. And a circular edge 28 for ultrasonic welding of the bottom cover 20 has a step-like structure formed by an inner high step and an outer low step, as shown in FIG. 1 and FIG. 2. Thus the opening edge 11 of the transparent container 10 is connected with the outer low step of the bottom cover 20 by ultrasonic welding to form a closed container 2. Thereby the welding procedures of the transparent container 10 with the bottom cover 20 are simplified and the residual bubbles on the welded area can be avoided. Thus the quality of the produced closed container 2 is improved.

The preferred disposition position of the bubble chamber 21 is under the bottom cover 20 projectingly and near the circular edge 28 of the bottom cover 20, as shown in FIG. 1. Yet the shape of the bubble chamber 21 is not limited to a cylinder. The bubble chamber 21 designed by such way not only provides sufficient space for hiding and receiving bubbles generated in the bubble chamber 21 but also saves the space, without occupying center position under the bottom cover 20. Thus the space for disposition of other components in the bottom base 30 is not affected. A plurality of components such as light emitting devise (LED) or other transmission mechanism can be mounted in the bottom base 30.

### Embodiment 2

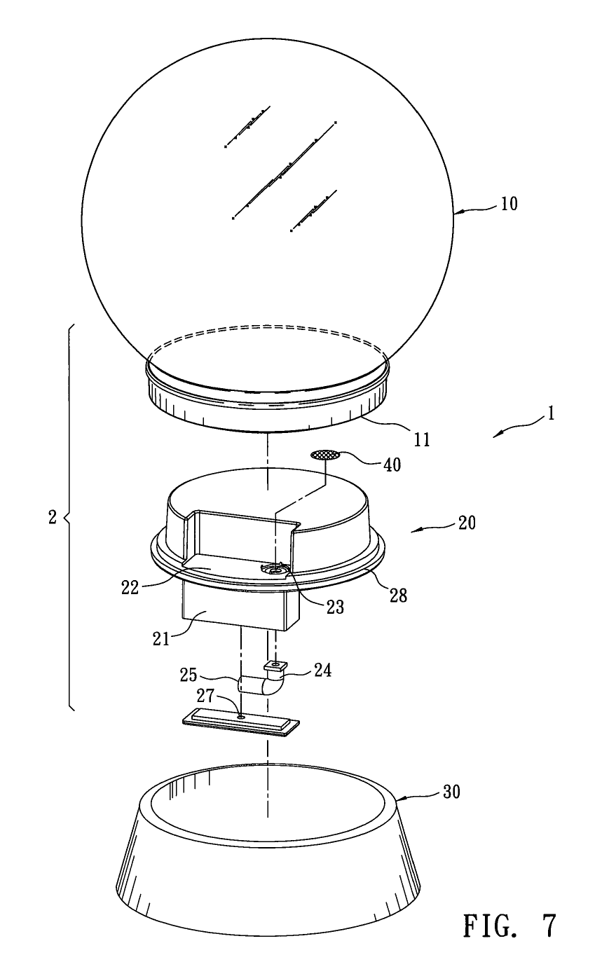

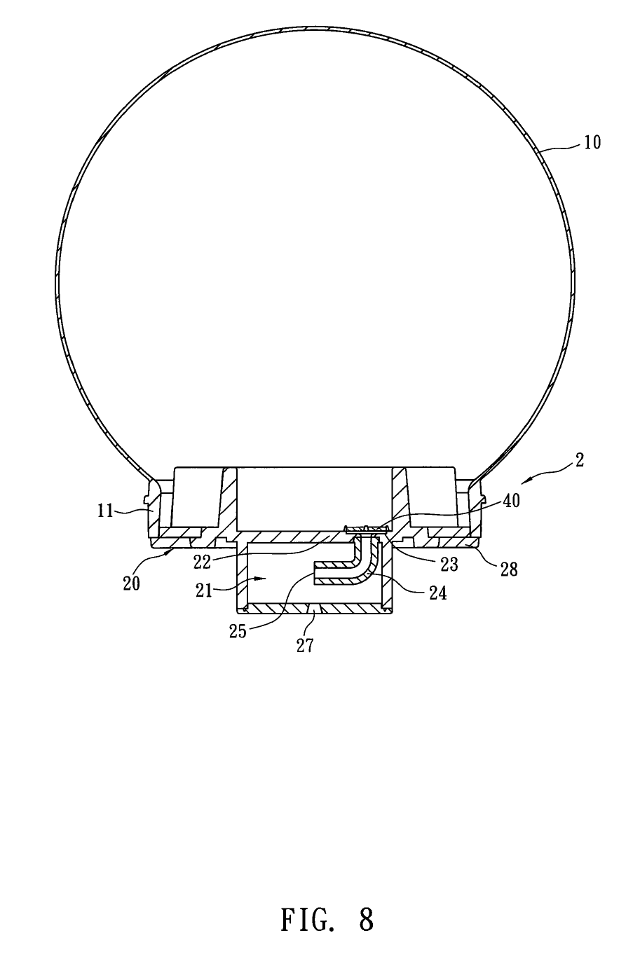

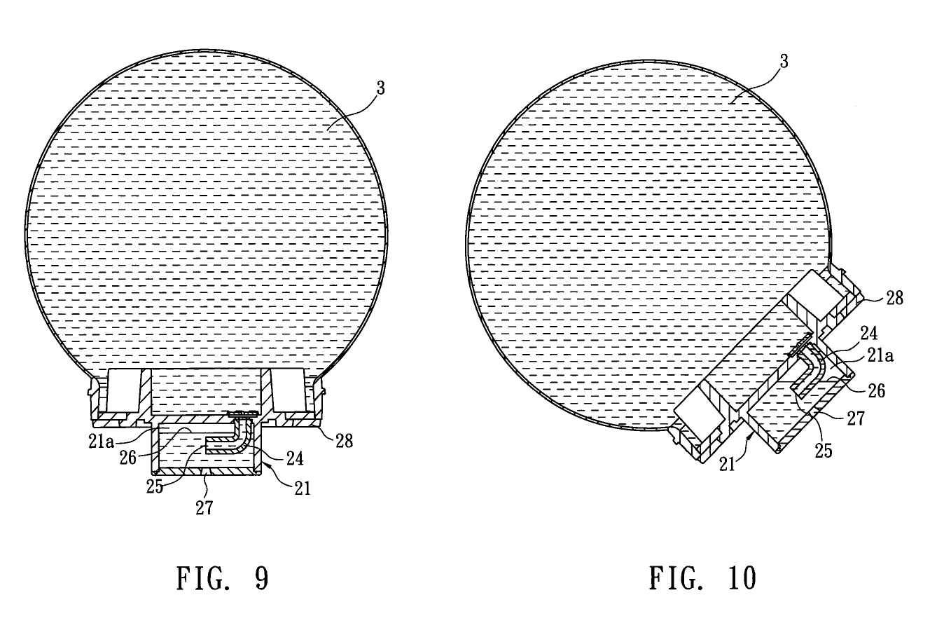

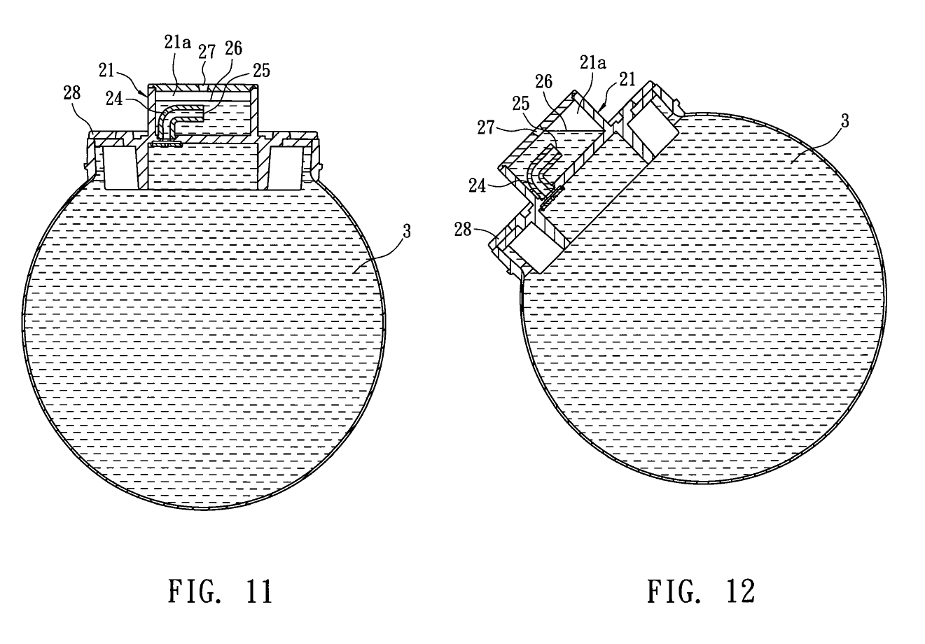

Refer from FIG. 7 to FIG. 12, another embodiment is disclosed. The structure and function of this embodiment are similar to those of the above one and the difference between the two embodiments is in that in this embodiment, a through hole 23 is mounted close to one side of a partition plate 22, as shown in FIG. 7. And a curved through tube 24 extends downward from the through hole 23 and a lower end opening 25 of the through tube 24 extends to a position near a center of a bubble chamber 21 so as to achieve similar effects of the above embodiment. The bubble chamber 21 is disposed projectingly under a bottom cover 20. And the shape of the bubble chamber 21 can be designed into a long rectangular or a curved cylinder disposed along a circular edge 28 of the bottom cover 20 so as to make a central space under the bottom cover 20 available for disposition of other components in the bottom base 30, as shown in FIG. 7.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A water ball ornament with at least one bubble chamber comprising:
a transparent container disposed with an opening edge on a bottom thereof,
a bottom cover for closing the opening edge on the bottom of the transparent container and connecting with the transparent container to form a closed container; a bubble chamber disposed projectingly under the bottom cover and divided with an inner space of the closed container by a partition plate; a through hole arranged at the partition plate while a through tube extending downward from the through hole so as to connect the inner space of the closed container with the bubble chamber and the through tube having a lower end opening extending to a position near a center of the bubble chamber so as to make a space above the lower end opening of the bubble chamber hide and receive bubbles generated in the closed container, and
a bottom base for loading and fixing the closed container,
wherein the liquid level is controlled to be over the lower end opening of the through tube when a liquid is filled into the closed container and the bubble chamber so that the liquid level in the bubble chamber is always higher than the lower end opening of the through tube and the lower end opening of the through tube is sunk into the liquid no matter the closed container is in a normal position, a tilted position, a reverse position, or a reverse tilted position so as to prevent bubbles in the bubble chamber from entering the through tube through the lower end opening and going back to the closed container.

2. The device as claimed in claim 1, wherein the through hole is arranged near a center of the partition plate.

3. The device as claimed in claim 1, wherein the through hole is disposed close to one side of the partition plate and a curved through tube extends downward from the through hole while a lower end opening of the through tube extends to a position near a center of the bubble chamber.

4. The device as claimed in claim 1, wherein a mesh screen is fixed and disposed above the through hole on the partition plate of the bottom cover so as to prevent foil fragments in the closed container from entering the through tube through the through hole.

5. The device as claimed in claim 1, wherein the transparent container is a ball-shaped container made of glass by blow molding.

6. The device as claimed in claim 1, wherein the transparent container is a ball-shaped container made of plastic by blow molding or injection blow molding.

7. The device as claimed in claim 6, wherein the transparent container and the bottom cover are integrated with each other by ultrasonic welding.

8. The device as claimed in claim 7, wherein a circular edge of the bottom cover is a step-like structure having an inner high step and an outer low step so that the opening edge of the transparent container is connected with the outer low step of the bottom cover by ultrasonic welding.
